(19) United States
(12) Patent Application Publication
(10) Pub. No.: US 2006/0074815 A1
(43) Pub. Date: Apr. 6, 2006

(54) Duplicate reception judgment unit

(75) Inventor: Hiroaki Ishida, Maebashi (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/295,628

(22) Filed: Dec. 7, 2005

Related U.S. Application Data
(63) Continuation of application No. PCT/JP03/10491, filed on Aug. 20, 2003.

(51) Int. Cl. H04L 9/00

(52) U.S. Cl. 705/71; 705/65

(57) ABSTRACT

A duplicate reception judgment unit for judging the duplicate reception in a transmission destination of transaction information about an electronic transaction transmitted from a transmission source to the transmission destination. The duplicate reception judgment unit includes a reception log storage section for storing as a reception log the transaction information received in the transmission destination, and a duplication judgment section for judging duplicate reception of judgment object transaction information received in the transmission destination, based on the reception log stored in the reception log storage section. In this manner, the duplicate reception in a transmission destination of transaction information can be reliably and easily judged.

### TECHNICAL FIELD

The present invention relates to the judgment of duplicate reception in a transmission destination of information transmitted from a transmission source to the transmission destination, and to a duplicate reception judgment unit, an electronic transaction unit, a duplicate reception judgment method, a duplicate reception judgment program, and a computer-readable storage medium storing the program which are suitable for receiving commercial transaction data in electronic commercial transactions.

### BACKGROUND ART

Typical, in electronic commercial transaction systems, transaction terminals (clients) and a server are connected so that they can communicate with each other, information (transaction data) about a request (e.g., purchase of merchandize) input from a transaction terminal (transmission source) is transmitted to the server (transmission destination), and the server processes the transaction data.

And in electronic commercial transaction systems, when transaction data is received from a transaction terminal, the server transmits an acknowledgment indicating that the transaction data has been received, to the transaction terminal that is a transmission source, regardless of whether or not the received transaction data is processed and the content.

When the acknowledgement has not been received from the server within a predetermined period of time since the transaction data was transmitted to the server, the transaction terminal transmits the same transaction data to the server again.

Therefore, in conventional electronic commercial transaction systems, in the case where an acknowledgment from a sever has not reached a transaction terminal for some reason even when the server received transaction data, the transaction terminal transmits the same transaction data again and the server duplicatively receives the same transaction data.

FIG. 11 is a diagram for explaining the mechanism of the occurrence of duplicate reception in a conventional electronic commercial transaction system. As shown in the figure, in the case where an acknowledgment from a server (receiving side or transmission destination) has not reached a transaction terminal (transmission source), there is a possibility that transaction data D1 will be duplicatively transmitted to the server and two sets of transaction data D1 will be duplicatively processed in the server.

Hence, in the conventional electronic commercial transaction system, a transaction terminal (transmission source) transmits transaction data and identification information capable of univocally identifying that transaction data, while a server receives the transaction data and the identification information, judges duplicate reception of the transaction data by using this identification information and identifying the transaction data, and prevents the duplicate processing.

However, in such a conventional electronic commercial transaction system, it is necessary to make various agreements about the form of identification information, a method of attachment to transaction data, etc., between a server and a transaction terminal and transmit transaction information from the transaction terminal according to these agreements.

Particularly, in the case of a server receiving transaction data from a plurality of transaction terminals, it is necessary to respectively prepare agreements for a duplication judgment of transaction data for these transaction terminals, so that the duplication judgment is not efficient.

In addition, for example, in the case of changing the data form of transaction data or identification information or adding a new transaction terminal, the server needs to perform inefficient operations for changes in the data duplication judgment process and addition of a transaction terminal.

In transmitting transaction data from a transaction terminal to a server, there are cases where the transaction data is compressed to reduce the amount of data to be transmitted, or is encrypted to ensure security.

Therefore, in the above-described transaction system, when compressed or encrypted transaction data is transmitted from a transaction terminal to a server, the server decompresses (or expands) or decodes (or decrypts) the transaction data before judging duplicate reception of the transaction data, and consequently, there is a possibility that the ability of the server to receive transaction data will be reduced.

The present invention has been made in view of the circumstances mentioned above. Accordingly, it is the object of the present invention to provide a duplicate reception judgment unit, an electronic transaction unit, a duplicate reception judgment method, a duplicate reception judgment program, and a computer-readable storage medium storing the program which are capable of preventing duplicate processing of transaction information by reliably and easily judging the duplicate reception of the transaction information in a transmission destination.

### SUMMARY OF THE INVENTION

To achieve the aforementioned object of the present invention, a duplicate reception judgment unit of the present invention is a duplicate reception judgment unit for judging the duplicate reception in a transmission destination of transaction information about an electronic transaction transmitted from a transmission source to the transmission destination. The duplicate reception judgment unit includes (1) a reception log storage section for storing as a reception log the transaction information received in the transmission destination, and (2) a duplication judgment section for judging duplicate reception of judgment object transaction information received in the transmission destination, based on the reception log stored in the reception log storage section.

In the duplicate reception judgment unit of the present invention, the duplication judgment section may compare the judgment object transaction information with the reception log stored in the reception log storage section, and when the same transaction information as the judgment object transaction information has been stored as the reception log in the reception log storage section, judge that the judgment object transaction information has been duplicatively received.

The duplicate reception judgment unit of the present invention may further include (1) a key information making section for making key information, based on the transaction information received in the transmission destination, and (2) a key information storage section for storing the key information made by the key information making section so that it is interrelated with the transaction information. In this case, the duplication judgment section may compare judgment object key information made based on the judgment object transaction information by the key information making section with the key information stored in the key information storage section, and when the same key information as the judgment object key information has been stored in the key information storage section, judge that the judgment object transaction information interrelated with the judgment object key information has been duplicatively received.

The duplicate reception judgment unit of the present invention may also include a key information making section for making key information, based on the transaction information received in the transmission destination, and a key information storage section for storing the key information made by the key information making section so that it is interrelated with the transaction information. In that case, (1) when judgment object key information made based on the judgment object transaction information by the key information making section is compared with the key information stored in the key information storage section, and the same key information as the judgment object key information has been stored in the key information storage section, and (2) when the reception log of the same key information as the judgment object key information stored in the reception log storage section is compared with judgment object transaction information, and they are the same, the duplication judgment section may judge that the judgment object transaction information has been duplicatively received. Note that the key information making section may make key information by applying a hash function to transaction information.

An electronic transaction unit of the present invention includes (1) a receiver section for receiving transaction information about an electronic transaction transmitted from a transmission source; (2) a transaction processing section for performing a transaction process based on the transaction information received by the receiver section; (3) a reception log storage section for storing as a reception log the transaction information received by the receiver section; and (4) a duplication judgment section for judging duplicate reception of judgment object transaction information received by the receiver section, based on the reception log stored in the reception log storage section. In this case, the transaction processing section does not perform the transaction process on the judgment object transaction information judged to be duplicate reception.

In the electronic transaction unit of the present invention, the duplication judgment section may compare the judgment object transaction information with the reception log stored in the reception log storage section, and when the same transaction information as the judgment object transaction information has been stored as the reception log in the reception log storage section, judge that the judgment object transaction information has been duplicatively received.

The electronic transaction unit of the present invention may further include (1) a key information making section for making key information, based on the transaction information received by the receiver section, and (2) a key information storage section for storing the key information made by the key information making section so that it is interrelated with the transaction information. In this case, the duplication judgment section may compare judgment object key information made based on the judgment object transaction information by the key information making section with the key information stored in the key information storage section, and when the same key information as the judgment object key information has been stored in the key information storage section, judge that the judgment object transaction information interrelated with the judgment object key information has been duplicatively received.

The electronic transaction unit of the present invention may also include a key information making section for making key information, based on the transaction information received by the receiver section; and a key information storage section for storing the key information made by the key information making section so that it is interrelated with the transaction information. In that case, (1) when judgment object key information made based on the judgment object transaction information by the key information making section is compared with the key information stored in the key information storage section, and the same key information as the judgment object key information has been stored in the key information storage section, and (2) when the reception log of the same key information as the judgment object key information stored in the reception log storage section is compared with judgment object transaction information, and they are the same, the duplication judgment section may judge that the judgment object transaction information has been duplicatively received. Note that the key information making section may make key information by applying a hash function to transaction information.

A duplicate reception judgment method of the present invention is a duplicate reception judgment method of judging duplicate reception, a transmission destination, of transaction information about an electronic transaction transmitted from a transmission source to the transmission destination. The method includes a reception log storage step of storing as a reception log the transaction information received in the transmission destination, and a duplication judgment step of judging duplicate reception of judgment object transaction information received in the transmission destination, based on the reception log stored in the reception log storage step.

Note that in the duplication judgment step, the judgment object transaction information may be compared with the reception log stored in the reception log storage section, and when the same transaction information as the judgment object transaction information has been stored as the reception log in the reception log storage section, it may be judged that the judgment object transaction information has been duplicatively received.

The duplicate reception judgment method of the present invention may further include a key information making step of making key information, based on the transaction information received in the transmission destination, and a key information storage step of storing the key information made in the key information making step so that it is interrelated with the transaction information. In the duplication judgment step, judgment object key information made based on the judgment object transaction information in the key information making step may be compared with the key information stored in the key information storage step, and when the same key information as the judgment object key information has been stored in the key information storage step, it may be judged that the judgment object transaction information interrelated with the judgment object key information has been duplicatively received.

The duplicate reception judgment method of the present invention may also include a key information making step of making key information, based on the transaction information received in the transmission destination, and a key information storage step of storing the key information made in the key information making step so that it is interrelated with the transaction information. In the duplication judgment step, (1) when judgment object key information made based on the judgment object transaction information in the key information making step is compared with the key information stored in the key information storage step, and the same key information as the judgment object key information has been stored in the key information storage section, and (2) when the reception log of the same key information as the judgment object key information stored in the reception log storage step is compared with judgment object transaction information, and they are the same, it may be judged that the judgment object transaction information has been duplicatively received. Note that in the key information making step, key information may be made by applying a hash function to transaction information.

A second duplicate reception judgment method of the present invention is a duplicate reception judgment method of judging duplicate reception, a transmission destination, of information about an electronic transaction transmitted from a transmission source to the transmission destination. The second judgment method includes a reception log storage step of storing as a reception log the information received in the transmission destination, and a duplication judgment step of judging duplicate reception of judgment object information received in the transmission destination, based on the reception log stored in the reception log storage step.

Note that in the duplication judgment step, the judgment object information may be compared with the reception log stored in the reception log storage section, and when the same information as the judgment object information has been stored as the reception log in the reception log storage section, it may be judged that the judgment object information has been duplicatively received.

The second duplicate reception judgment method of the present invention may further include a key information making step of making key information, based on the information received in the transmission destination, and a key information storage step of storing the key information made in the key information making step so that it is interrelated with the information. In the duplication judgment step, judgment object key information made based on the judgment object information in the key information making step may be compared with the key information stored in the key information storage step, and when the same key information as the judgment object key information has been stored in the key information storage step, it may be judged that the judgment object information interrelated with the judgment object key information has been duplicatively received.

The second duplicate reception judgment method of the present invention may also include a key information making step of making key information, based on the information received in the transmission destination, and a key information storage step of storing the key information made in the key information making step so that it is interrelated with the information. In the duplication judgment step, (1) when judgment object key information made based on the judgment object information in the key information making step is compared with the key information stored in the key information storage step, and the same key information as the judgment object key information has been stored in the key information storage section, and (2) when the reception log of the same key information as the judgment object key information stored in the reception log storage step is compared with judgment object information, and they are the same, it may be judged that the judgment object information has been duplicatively received. Note that in the key information making step, key information may be made by applying a hash function to information.

A duplicate reception judgment program of the present invention is a duplicate reception judgment program for judging duplicate reception, a transmission destination, of transaction information about an electronic transaction transmitted from a transmission source to the transmission destination. The duplicate reception judgment program causes a computer to carry out: a reception log storage step of storing as a reception log the transaction information received in the transmission destination; and a duplication judgment step of judging duplicate reception of judgment object transaction information received in the transmission destination, based on the reception log stored in the reception log storage step.

Note that in causing the computer to carry out the duplication judgment step, the computer may compare the judgment object transaction information with the reception log stored in the reception log storage step, and when the same transaction information as the judgment object transaction information has been stored as the reception log in the reception log storage step, judge that the judgment object transaction information has been duplicatively received.

The duplicate reception judgment program may further cause the computer to carry out: a key information making step of making key information, based on the transaction information received in the transmission destination; and a key information storage step of storing the key information made in the key information making step so that it is interrelated with the transaction information. And in causing the computer to carry out the duplication judgment step, the computer may compare judgment object key information made based on the judgment object transaction information in the key information making step with the key information stored in the key information storage step, and when the same key information as the judgment object key information has been stored in the key information storage step, judge that the judgment object transaction information interrelated with the judgment object key information has been duplicatively received.

The duplicate reception judgment program may also cause the computer to carry out: a key information making step of making key information, based on the transaction information received in the transmission destination; and a key information storage step of storing the key information made in the key information making step so that it is interrelated with the transaction information. And in causing the computer to carry out the duplication judgment step, (1) when judgment object key information made based on the judgment object transaction information in the key information making step is compared with the key information stored in the key information storage step, and the same key information as the judgment object key information has been stored in the key information storage section, and (2) when the reception log of the same key information as the judgment object key information stored in the reception log storage step is compared with judgment object transaction information, and they are the same, the computer may judge that the judgment object transaction information has been duplicatively received. Note that in causing the computer to carry out the key information making step, the computer may make key information by applying a hash function to transaction information.

A computer-readable storage medium of the present invention has stored the above-described duplicate reception judgment program.

Thus, according to the present invention, the duplicate reception judgment unit, electronic transaction unit, duplicate reception judgment method, duplicate reception judgment program, and computer-readable storage medium storing the program has the following advantages:

(1) As to judgment object transaction information received in a transmission destination, duplicate reception of the judgment object transaction information is judged based on a reception log, so the duplicate reception can be easily and reliably judged.

(2) In transmission sources, it is not necessary to perform special processes on judgment object transaction information, etc.

(3) The key information made based on transaction information received in a transmission destination is stored so that it is interrelated with the transaction information. When judgment object key information made based on judgment object transaction information is compared with key information stored, and the same key information as the judgment object key information has been stored, it is judged that the judgment object transaction information interrelated with the judgment object key information has been duplicatively received. Thus, since it is not necessary to directly compare and judge transaction information, the duplication judgment process can be performed at high speed.

(4) The key information made based on transaction information received in a transmission destination is stored so that it is interrelated with the transaction information. In this case, (1) when judgment object key information made based on judgment object transaction information is compared with key information stored, and the same key information as the judgment object key information has been stored, and (2) when the reception log of the same key information as the judgment object key information is compared with judgment object transaction information, and they are the same, it is judged that the judgment object transaction information has been duplicatively received. Since this can reduce the reception log that is directly compared and judged with respect to judgment object transaction information, the process of judging the duplicate reception of transaction information can be performed at high speed.

(5) After a judgment of duplication is made between judgment object key information and the key information stored in the key information storage section, a judgment of duplication is made between judgment object transaction information and the reception log. Thus, because double duplication judgments are made, the reliability of the judgment result of duplicate reception is high.

### BRIEF DESCRIPTION OF THE DRAWINGS

FIG. 1 is a diagram schematically showing an electronic transaction system constructed in accordance with a first embodiment of the present invention;

FIG. 2 is a diagram showing an example of a reception log database stored in the reception log storage section of the electronic transaction system of the first embodiment of the present invention;

FIG. 3 is a diagram for explaining the flow of transaction data in the electronic transaction system constructed in accordance with the first embodiment of the present invention;

FIG. 4 is a diagram schematically showing the structure of transmission data in the electronic transaction system constructed in accordance with the first embodiment of the present invention;

FIG. 5 is a diagram schematically showing how processing is performed when transaction data is duplicatively received in the electronic transaction system of the first embodiment of the present invention;

FIG. 6 is a diagram schematically showing an electronic transaction system constructed in accordance with a second embodiment of the present invention;

FIG. 7 is a diagram showing an example of a key information database stored in the key information storage section of the electronic transaction system of the second embodiment of the present invention;

FIG. 8 is a diagram showing an example of a LOGid collection list made by the duplication judgment section of the electronic transaction system of the second embodiment of the present invention;

FIG. 9 is a flowchart for explaining how transaction data is processed when it is received in the transaction server of the electronic transaction system of the second embodiment of the present invention;

FIG. 10 is a flowchart for explaining how duplicate reception is judged by the electronic transaction system of the second embodiment of the present invention; and

FIG. 11 is a diagram for explaining the mechanism of the occurrence of duplicate reception in a conventional electronic commercial transaction system.

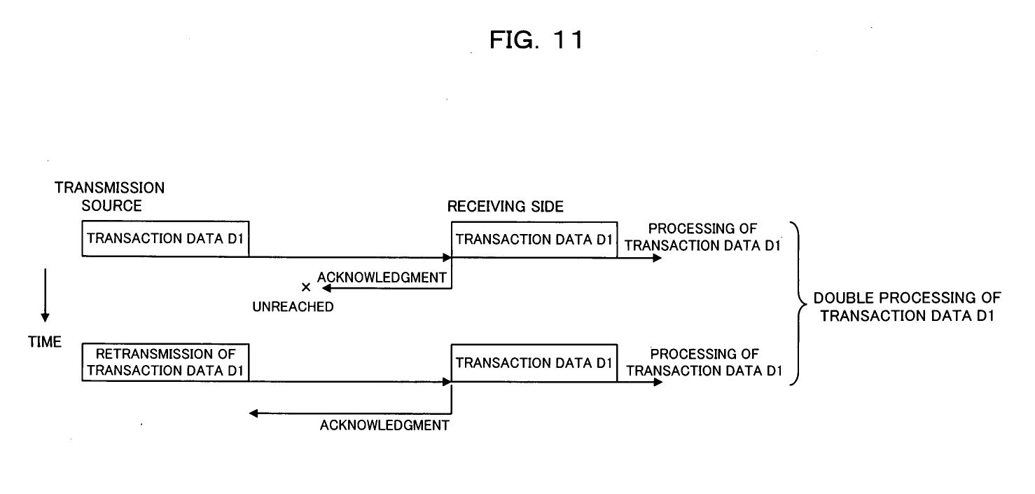

### BEST MODE FOR CARRYING OUT THE INVENTION

Embodiments of the present invention will hereinafter be described with reference to the drawings.

### (A) Description of First Embodiment

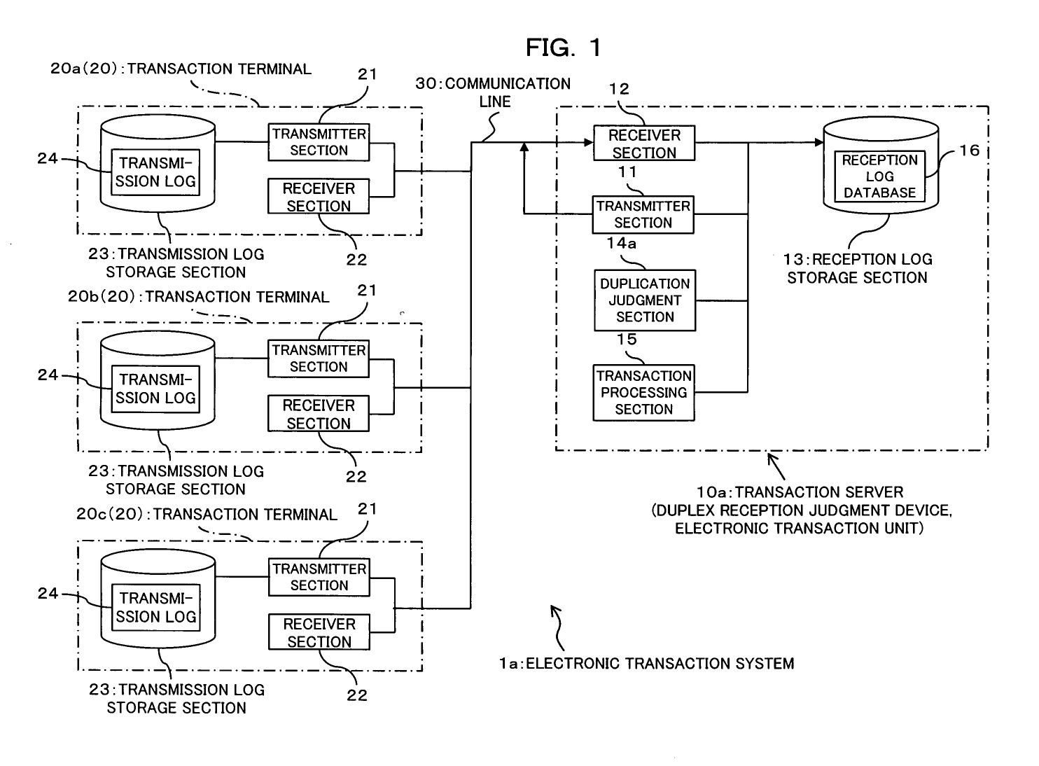

FIG. 1 schematically shows an electronic transaction system constructed in accordance with a first embodiment of the present invention. The electronic transaction system 1a of the first embodiment realizes various transactions (electronic transactions) through computer systems and is constructed by connecting a plurality of transaction terminals (transmission sources) 20a, 20b, and 20c (20) and a transaction server (a duplicate reception judgment unit or electronic transaction unit at a receiving side) 10a through a communication line 30 so that they can communicate with each other. In this embodiment, the plurality of transaction terminals comprise three transaction terminals 20a, 20b, and 20c.

Each of the transaction terminals 20a, 20b, and 20c is used to input various kinds of information about electronic transactions. In this embodiment, in conducting electronic transactions, operators or customers are able to input various signals, employing these transaction terminals 20a, 20b, and 20c.

Note that the transaction terminals 20a, 20b, and 20c are nearly the same in construction. Therefore, in the following description, reference numeral 20a, 20b, or 20c is employed to specify one of the transaction terminals, while reference numeral 20 denotes an arbitrary transaction terminal.

The transaction terminal 20, for instance, is constructed by a computer system (not shown) equipped with an input device capable of inputting various kinds of information about transactions. Based on information input by an operator, etc., the transaction terminal 20 acquires the transaction data about that transaction and transmits it to the transaction server 10a through the communication line 30.

The transaction data (transaction information, or information) are various kinds of information about electronic transactions. For example, in the case of buying or selling a commodity as an electronic transaction (electronic commercial transaction), information to specify the commodity, price information, customer information, etc., are transaction information. In the case of conducting, for example, net banking or online banking as electronic transactions, information, such a transaction instruction (a cash transfer to another's bank account, etc.), an amount of money, etc., corresponds to transaction data.

The transaction terminal 20 is also equipped with a transmitter section 21 for transmitting the above-described transaction data to the transaction server 10a, and a receiver section 22 for receiving information transmitted from the transaction server 10a. It is further equipped with a transmission log storage section 23 for storing as a transmission log 24 the transaction data transmitted from the transmitter section 21.

The transaction terminal 20 further judges whether an acknowledgment (to be described later) for the transaction data transmitted to the transaction server 10a has reached from the transaction server 10a within a predetermined period of time since that transaction data was transmitted. In the case where an acknowledgment does not reach from the transaction server 10a within the predetermined period of time, the transaction terminal 20 judges that the transaction data has not reached the transaction server 10a, and retransmits the same transaction data to the transaction server 10a.

In the transaction terminal 20, for instance, a network interface unit (NIU) in a computer system functions as a transmitter section 21 and a receiver section 22, and a storage device, such as a hard disk, memory, etc., functions as a transmission log storage section 23. Note that various kinds of information received from the transaction server 10a by the receiver section 22 may be stored as a reception log in a storage device, such as a hard disk, memory, etc.

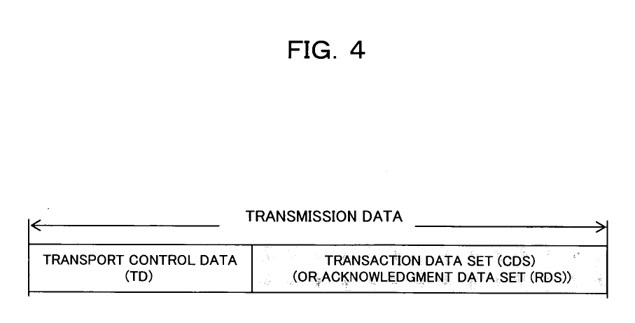

In the first embodiment, in the case of transmitting transaction data from the transmitter section 21 of the transaction terminal 20 to the transaction server 10a, the transaction data is transmitted as transmission data (which will be described in detail later in FIG. 4) generated so as to contain the transaction data.

The communication line 30 connects the transaction terminal 20 and transaction server 10a so that they can communicate with each other. The communication line 30, for instance, is realized by a local area network (LAN), a public line, a dedicated line, the Internet constructed by connecting these together, etc.

The transaction server 10a conducts various electronic transactions, based on transaction data transmitted by the transaction terminal 20. As shown in FIG. 1, the transaction server 10a is equipped with a transmitter section 11, a receiver section 12, a reception log storage section 13, a duplication judgment section 14a, and a transaction processing section 15.

The receiver section 12 receives various kinds of information transmitted to the transaction server 10a and also receives transaction data (transmission data) transmitted from the transaction terminal 20. The receiver section 12 further sends the received transaction data to the reception log storage section 13. The reception log storage section 13 stores the received transaction data as a reception log in a reception log database 16. The receiver section 12 also sends the received transaction data to the duplication judgment section 14a.

The transmitter section 11 transmits various kinds of information about electronic transactions from the transaction server 10a to the transaction terminal 20 through the communication line 30. In the transaction server (transmission destination) 10a, when transaction data from the transaction terminal 20 is received by the receiver section 12, the transmitter section 11 transmits an acknowledge indicating that the transaction data has been received, to the transaction terminal 20 of the transmission source of the received transaction data, regardless of the processing and content of the received transaction data. Note that the acknowledgment is to be described in detail later.

In the transaction server 10a, for instance, a network interface unit in a computer system functions as the transmitter section 12 and receiver section 11.

The reception log storage section 13 stores as a reception log in the reception log database 16 the transaction data received by the receiver section 11. For example, a storage device, such as a hard disk, etc., in a computer system functions as this reception log storage section 13.

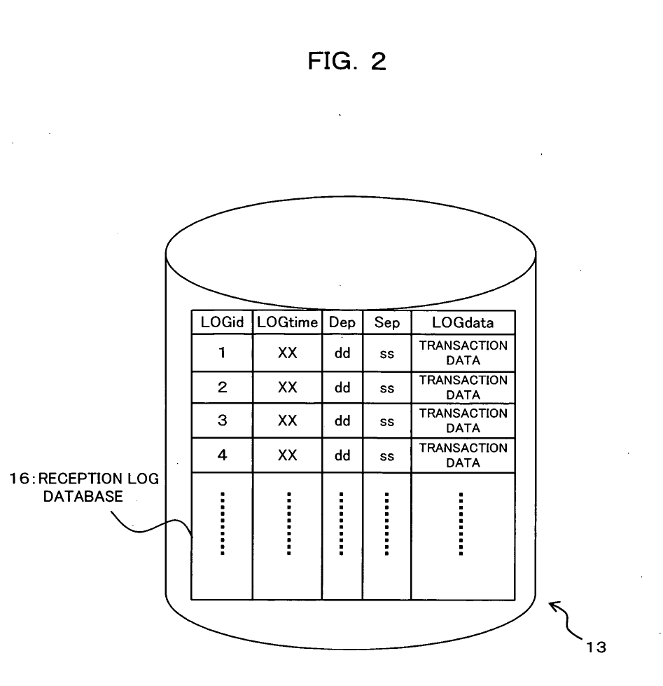

FIG. 2 is a diagram showing an example of the reception log database 16 stored in the reception log storage section 13 of the electronic transaction system 1a of the first embodiment of the present invention.

As shown in the figure, the reception log database 16 in this embodiment is constructed as a database table consisting of LOGid, LOGtime, Dep, Sep, and LOGdata columns. According to the transaction data (LOGdata) received by the receiver section 12, the LOGid, LOGtime, Dep, and Sep columns are stored so that they correspond to each other.

The “LOGid” column in the reception log database 16 indicates information (identifier) that univocally specifies the transaction data received by the receiver section 12, and is set in storing the transaction data in the reception log database 16. This “LOGid” column is a primary key in the reception log database 16 and can employ, for example, a numerical value incremented by 1 each time transaction data is stored in the reception log database 16.

Note that, in the electronic transaction system 1a of the first embodiment, all data received are stored in the reception log database 16. Therefore, in the following description, there are cases where judgment object transaction data (judgment object transaction information or judgment object information), which is an object of judgment for duplicate reception, is represented by adding “p” to the front position of each reference character. That is, in sending judgment object transaction data to the duplication judgment section 14a, an identifier for this reception log record (pLOGid) is sent along with that judgment object transaction data.

The “LOGtime” column in the reception log database 16 indicates the day and time when the transaction data received by the receiver section 12 was written to the reception log database 16. The “Dep” column in the reception log database 16 indicates information identifying the transmission destination of transaction data. For example, in the case of information being transmitted between the transaction terminal 20 and the transaction server 10a according to the Open Systems Interconnection (OSI) reference model, the receiving-side endpoint identification information transferred from the transport layer is employed. Note in FIG. 2 that the “LOGtime” column shows XX's for convenience, but actually indicates the aforementioned day and time.

The “Sep” column in the reception log database 16 indicates information that specifies the transmission source of transaction data. For instance, when information is transmitted between the transaction terminal 20 and the transaction server 10a according to the OSI reference model, the transmitting-side end point identification information transferred from the transport layer is employed.

In this embodiment, the “Dep” column indicates receiving-side end point identification information, while the “Sep” column indicates transmitting-side end point identification information. Note in FIG. 2 that the “Dep” and “Sep” columns show dd's and ss's for convenience, but actually indicate a receiving-side end point and a transmitting-side end point.

In the “LOGdata” column, the transaction data received by the receiver section 12 is stored as it is. For example, in the case where transaction data transmitted from the transaction terminal 20 has been encrypted or compressed, the encrypted or compressed transaction data is stored in the reception log storage section 13.

In electronic transactions, to cope with trouble after a fact, the whole sentence of transaction data received, the identification information about the transmission source, and the reception entry information at the receiving side are generally stored as a transaction log. In the present invention, by employing in the reception log database 16 the transaction log stored in this way, the electronic transaction system 1a (or 1b; to be described later) of the present invention can be readily applied to existing electronic transaction systems.

The present invention is also able to set a term of validity to the transaction data stored in the reception log storage section 13 (reception log database 16). If the term of validity of transaction data expires, it may be deleted from the reception log storage section 13 (reception log database 16). Since this makes it possible to reduce the capacity of the reception log storage section 13, the time required for the duplication judgment section 14a (which is to be described) to perform a duplication judgment process on transaction data can be shortened, and device costs can be reduced.

The duplication judgment section 14a judges the duplicate reception of transaction data, based on the transaction data received by the receiver section 12 and the reception log database 16 stored in the reception log storage section 13. More specifically, the duplication judgment section 14a compares the transaction data (judgment object transaction data; judgment object transaction information or judgment object information) received by the receiver section 12 with the reception log database 16 stored in the reception log storage section 13, and when the same transaction data as the judgment object transaction data has been stored as a reception log in the reception log storage section 13 (reception log database 16), judges that the transaction data has been duplicatively received.

In this embodiment, transaction data (judgment object data) itself that is an object of judgment for duplicate reception is stored as a reception log in the reception log storage section 13 (reception log database 16) when received by the receiver section 12, but it is a matter of course that such judgment object transaction data is excluded from an object of comparison for a duplication judgment.

In addition, for example, in the case where transaction data transmitted from the transaction terminal 20 has been encrypted or compressed, the duplication judgment section 14a compares the encrypted or compressed judgment object transaction data with similarly encrypted or compressed transaction data that has been stored in the reception log storage section 13.

The duplication judgment section 14a, if judging that judgment object transaction data has been duplicatively received, sends that effect to the transaction processing section 15. In this embodiment, the duplication judgment section 14a sets as duplication information a duplication flag (Dupflag) that is particular information indicating that judgment object transaction data has been duplicatively received.

The transaction processing section 15 receives transaction data transmitted from the transaction terminal 20 and processes the electronic transaction. For instance, in the case of selling a commodity as an electronic transaction (electronic commercial transaction), the transaction processing section 15 receives transaction data (ordering information, etc.) transmitted from the transaction terminal 20 and performs various processes (e.g., an order receiving process, a delivery process, various accounting processes, etc.) relating to the selling of the commodity.

In addition, in the case where transaction data transmitted from the transaction terminal 20 has been encrypted or compressed, the transaction processing section 15 decodes (decrypts) or decompresses (expands) the transaction data.

The transaction processing section 15 further judges the content of the duplication information sent from the duplication judgment section 14a along with transaction data. When the duplication information does not contain a duplication flag indicating duplicate reception (Dupflag=False), the transaction processing section 15 performs a transaction process, employing the transaction data. On the other hand, when the duplication information contains the duplication flag (Dupflag=True), the transaction processing section 15 finishes processing without processing the transaction data.

That is, in the transaction system 1a, the transaction processing section 15 does not process transaction data judged to have been duplicatively received by the duplication judgment section 14a.

In the case of conducting an electric commercial transaction as an electric transaction, the transaction processing section 15 may present various kinds of information, relating to the selling of commodities, such as commercial names, reference numbers, selling prices, etc.

In the case of employing a HTTP POST method as a transmission protocol between a transmitting side and a receiving side, the HTTP header information and lower protocol information (a TCP header, an IP heater, etc.) correspond to transport control data TD and the POST data corresponds to a transaction data set CDS.

In addition, in the case of employing electronic mail as means for transmitting and receiving transaction data between a transmitting side and a receiving side, the SMTP header information and lower protocol information (a TCP header, an IP heater, etc.) correspond to transport control data TD and the mail data corresponds to a transaction data set CDS.

In the case of employing the Japanese Bankers Association Standard Communication Protocol (JBA-SCP) as a transmission protocol between a transmitting node and a receiving node, data in the transport layer defined in JBA-SCP corresponds to transport control data TD.

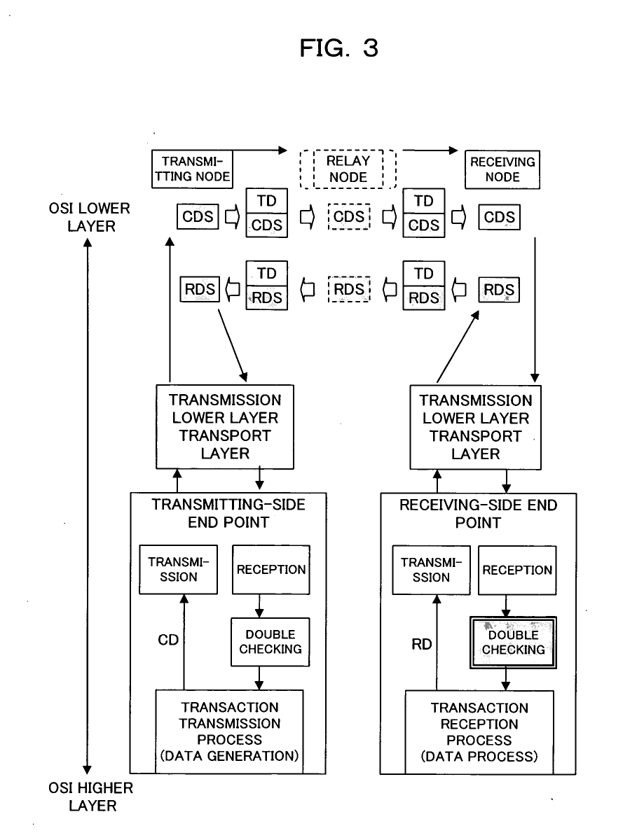

The flow of transaction data in the electronic transaction system 1a of the first embodiment of the present invention constructed as described above will be described with FIG. 3 by referring to FIG. 4. Note that FIG. 4 is a diagram schematically showing the structure of the transmission data in the electronic transaction system 1a of the first embodiment of the present invention.

Note in FIG. 3 that commercial transaction data is represented by reference character CD and acknowledgment data by reference character RD. Also, in the figure, the transaction terminal 20 is represented as a transmitting node and the transaction server 10a as a receiving node. Furthermore, there is shown a relay node between the transmitting node and the receiving node. This relay node retransmits various data between the transmitting node and the receiving node. Depending upon the structure of the communication line 30, there is no relay node between the transmitting node and the receiving node.

In the electronic transaction system 1a, as shown in FIG. 3, transaction data CD is transmitted as a transaction data set CDS that contains the transaction data CD, from the transmitting node to the receiving node. Also, acknowledgment data RD is transmitted as an acknowledgment data set RDS that contains the acknowledgment data RD, from the receiving node to the transmitting node.

The transaction data set CDS contains transmitting-side end point identification information (“Sep”), receiving-side end point identification information (“Dep”), transaction data identification information, and transaction data CD. The transaction data set CDS is generated at a transmitting-side end point and processed at a receiving-side end point. Also, the acknowledgment data set RDS contains transmitting-side end point identification information (“Sep”), receiving-side end point identification information (“Dep”), transaction data identification information, and acknowledgment data RD. The acknowledgment data set RDS is generated at a receiving-side end point and processed at a transmitting-side end point.

The transaction data identification information is information to univocally specify transaction data CD between a transmitting-side end point and a receiving-side endpoint, and employs, for instance, a transaction serial number, etc.

In the case of transmitting the transaction data set CDS from the transmitting node to the receiving node, as shown in FIG. 3, transmission data (see FIG. 4) is made in the transmitting node by attaching transport control data TD to the transaction data set CDS and is transmitted to the receiving node. Likewise, In the case of transmitting the acknowledgment data set RDS from the receiving node to the transmitting node, as shown in FIG. 3, transmission data (see FIG. 4) is made in the receiving node by attaching transport control data TD to the acknowledgment data set RDS and is transmitted to the transmitting node.

The transport control data TD is information to transfer the transaction data set CDS or acknowledgment data set RDS to a destination node. In a transmitting node, it is attached to the transaction data set CDS or acknowledgment data set RDS according to a transmission protocol. In the case of a relay node being arranged between transmitting and receiving nodes, there are cases where the transport control data TD is regenerated in the relay node.

Note in FIG. 3 that the upper portion of the figure corresponds to the higher layer in the OSI reference model, while the lower portion corresponds to the lower layer in the OSI reference model.

Also, in the example shown in FIG. 4, there is shown an example of a transmission protocol for attaching the transport control data TD only to the front position of the transaction data set CDS or acknowledgment data set RDS. The present invention is not to be limited to this example, but may be modified within the scope of the invention claimed. For example, the transport control data TD may be attached only to the end position of the transaction data set CDS or acknowledgment data set RDS. It may also be attached to both the front and end positions of the transaction data set CDS or acknowledgment data set RDS. Moreover, a portion of the transaction data set CDS or acknowledgment data set RDS may be employed as the transport control data TD.

In the transmitting node, by performing a transaction transmission process in the transmitting-side end point according to a signal input by an operator, transaction data CD is made in the higher layer and transmitted to the transport layer or transmission lower layer (network layer). In the end point, the transmitted transaction data CD is stored in the transmission log storage section 23 as the transmission log 24 (see FIG. 1).

In the transport layer or transmission lower layer, transmitting-side end point identification information or receiving-side end point identification information, transaction data identification information, etc., are attached to transaction data CD to generate transaction data set CDS. By further attaching transport control data TD to the generated transaction data set CDS, transmission data is generated and is transmitted to the receiving node (in some cases, data is transmitted to the receiving node through a relay node).

In the receiving side, the transaction data set CDS is obtained from the transmission data, and through the transmission lower layer or transport layer, the transaction data CD, transmitting-side end point identification information, and receiving-side endpoint identification information are sent to the receiving-side end point.

In the following description, for the transaction data (judgment object transaction data) which is an object of judgment for duplicate reception obtained in the receiving-side end point, to discriminate the transmitting-side end point identification information and receiving-side end point identification information from the transmitting-side end point identification information (“Sep”) and receiving-side end point identification information (“Dep”) stored as the reception log database 16 in the reception log storage section 13, there are cases where the transmitting-side end point identification information obtained in the receiving-side end point is represented by reference character “pSep” and the receiving-side end point identification information obtained in the receiving-side end point is represented by reference character “pDep.”

In the receiving-side end point, the received transaction data CD, transmitting-side end point identification information, and receiving-side endpoint identification information are stored in the reception log storage section 13 (see FIG. 1) as the reception log database 16, and to judge whether the transaction data has been duplicatively received, the transaction data, transmitting-side end point identification information (“pSep”), receiving-side end point identification information (“pDep”), and reception log record identifier (“pLOGid”) are sent to the duplication judgment section 14a. The duplication judgment section 14a judges whether the transaction data CD has been duplicatively received, and in the case of duplicate reception, sets to duplication information (“Dupflag”) a duplication flag indicating that effect.

When no duplication flag is set to duplication information (“Dupflag”), the transaction processing section 15 performs a transaction process, employing the transaction data CD. On the other hand, when a duplication flag is set to duplication information (“Dupflag”), the transaction processing section 15 excludes the transaction data from a processing object without processing it.

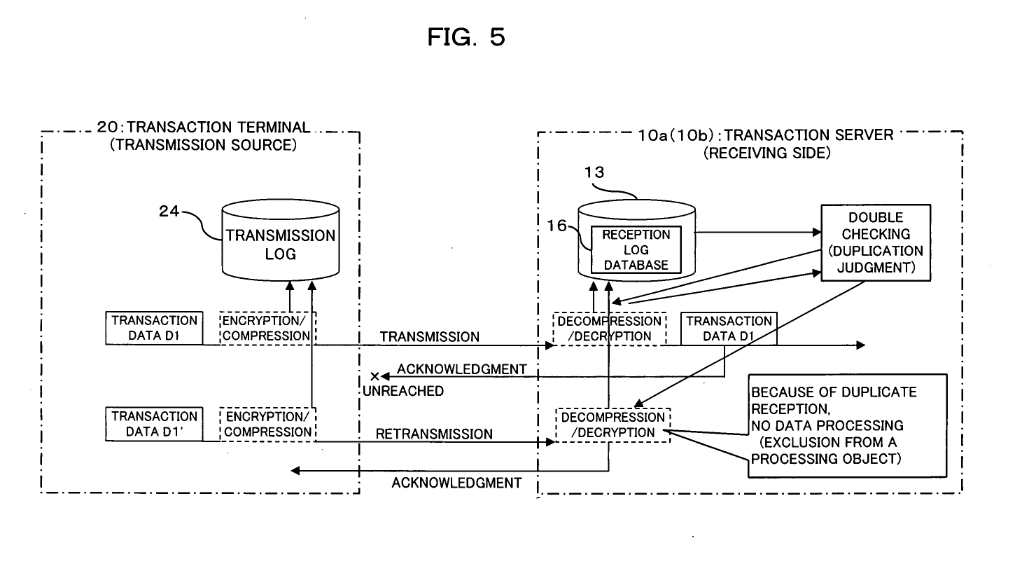

FIG. 5 is a diagram schematically showing how processing is performed when transaction data is duplicatively received in the electronic transaction system 1a of the first embodiment of the present invention. In the example shown in the figure, the transaction terminal (transmission source) 20 transmitted transaction data D1 by encrypting or compressing it, the transaction server 10a received the transaction data D1 and transmitted an acknowledgment to the transaction terminal 20, but the acknowledgment did not reach the transaction terminal 20 for some reason. In this case, the transaction terminal 20 transmits the same transaction data D1′ to the transaction server 10a again.

At first, the transaction data D1 transmitted from the transaction terminal 20 has been stored in the reception log database 16 of the reception log storage section 13. In this condition, the transaction server 10a makes a duplicate reception judgment of the transaction data D1′ by comparing the transaction data D1′ (judgment object transaction data) retransmitted from the transaction terminal 20 with the reception log of the reception log database 16 stored in the reception log storage section 13. As a result of this duplicate reception judgment, when it is judged that the transaction data D1′ has been duplicatively received, the transaction processing section 15 processes only the transaction data D1 first received, and the retransmitted transaction data D1′ is not processed.

Note that when it is judged by the duplication judgment section 14a that judgment object transaction data has been duplicatively received, the transaction processing section 15 is able to process only one of the two transaction data and exclude the other transaction data. That is, when it is judged by the duplication judgment section 14a that the transaction data D1′ is the same as the transaction data D1, the transaction processing section 15 may process either the transaction data D1′ or the transaction data D1.

Thus, according to the electronic transaction system 1a of the first embodiment of the present invention, the duplication judgment section 14a makes a duplicate reception judgment of the judgment object transaction data received in the receiver section 12, based on the reception log stored in the reception log storage section 13 (reception log database 16). And when it is judged that the judgment object transaction data has been duplicatively received, the duplication judgment section 14a sets to duplication information (“Dupflag”) a duplication flag indicating that effect. When the duplication flag indicating duplicate reception is set to the duplication information (“Dupflag”), the transaction processing section 15 does not process the transaction data. Therefore, even when transaction data is duplicatively received, there is no possibility that the transaction processing section 15 will process the transaction data. Thus, the present invention is capable of enhancing reliability.

In addition, the duplication judgment section 14a compares transaction data received by the receiver section 12 with the reception log stored in the reception log storage section 13, and when the same data as the transaction data has been stored as a reception log in the reception log storage section 13, judges that the transaction data has been duplicatively received. In this manner, a duplicate reception judgment of transaction data can be easily and reliably made.

In the case where transaction data received by the receiver section 12 has been compressed or encrypted, the compressed or encrypted transaction data is stored in the reception log database 16 without being decompressed or decrypted. And the duplication judgment section 14a makes a judgment of duplicate reception, based on the compressed or encrypted transaction data. Therefore, a judgment of duplicate reception can be quickly made, and there is no possibility that the ability of the transaction server 10a to receive data will be reduced.

All of the processes relating to a duplicate reception judgment of transaction data can be performed in the transaction server 10a. Therefore, between the transaction terminal 20 and the transaction server 10a, it is not necessary to conclude various agreements on transaction data for judging duplicate reception. Even when electronic transactions are conducted between a plurality of transaction terminals 20, or even when a new transaction terminal 20 is added, the present invention is very convenient to use.

In the transaction terminal 20 which is the transmission source of judgment object transaction data, it is not necessary to perform special processes on judgment object transaction data, so the present invention can be very conveniently used.

### (B) Description of Second Embodiment

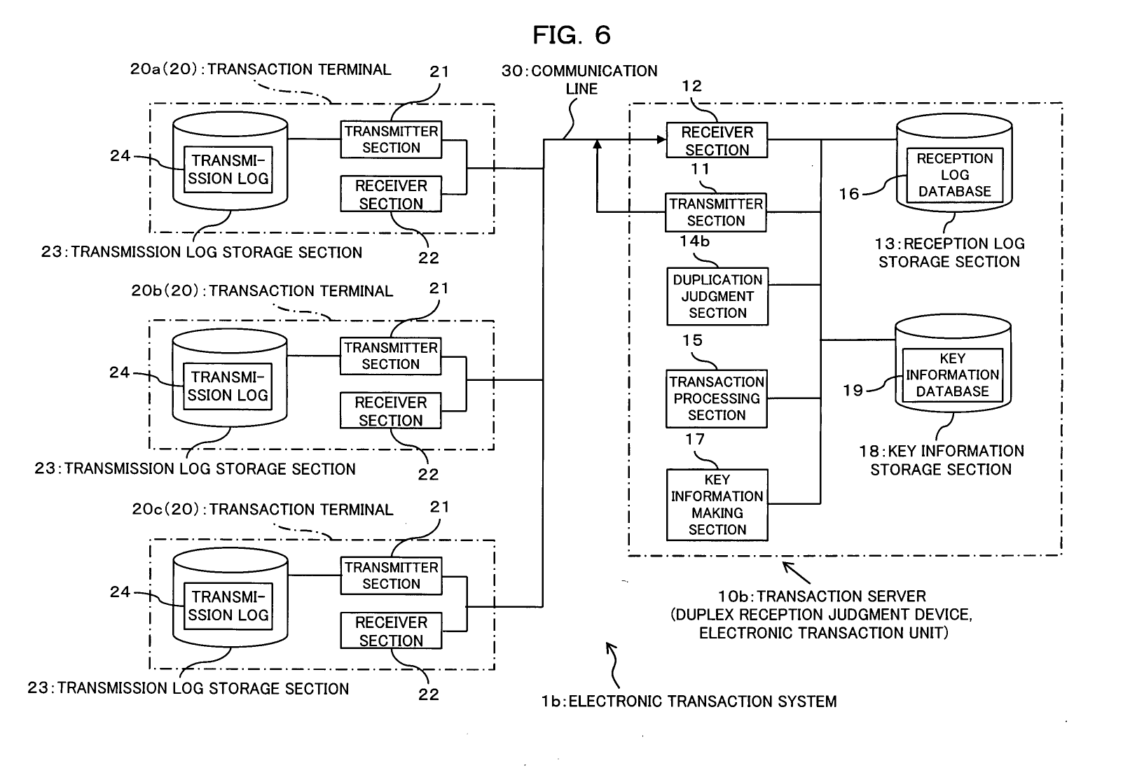

FIG. 6 schematically shows an electronic transaction system constructed in accordance with a second embodiment of the present invention. The electronic transaction system 1b of the second embodiment, as with the electronic transaction system 1a of the first embodiment (see FIG. 1), realizes various transactions (electronic transactions) through computer systems. As shown in FIG. 6, the electronic transaction system 1b is equipped with a transaction server 10b instead of the transaction server 10a of the first embodiment, and the remaining sections are constructed the same as the electronic transaction system 1a of the first embodiment.

The transaction server 10b is equipped with a key information making section 17 and a key information storage section 18 in addition to the transaction server 10a of the first embodiment and is further equipped with a duplication judgment section 14b instead of the duplication judgment section 14a. The remaining sections are constructed the same as the transaction server 1a of the electronic transaction system 1a of the first embodiment. In FIG. 6, the same reference numerals as the aforementioned reference numerals denote the same or nearly the same sections, so a description of the corresponding sections will not be given.

The key information making section 17 makes key information by applying a hash function to transaction data (transaction information) received by a receiving section 12. That is, key information is made based on transaction data.

The key information is made based on transaction data so that its capacity becomes smaller than that of the transaction data. For example, a digest (identifier) that has summarized the content of transaction data by the use of a message compression technique can be employed as the key information.

In the electronic transaction system 1b of the second embodiment, the key information making section 17 generates a hash value by applying a hash function to transaction data, using the message compression algorithm (message digest function algorithm) of the Message Digest 5 (MD5). The hash value is employed as the key information. Note that the hash function means a one-directional summary function and is a method of producing random numbers of a fixed length from transaction data.

For example, in the case where transaction data transmitted from the transaction terminal 20 has been encrypted or compressed, the key information making section 17 makes key information by applying the hash function to the encrypted or compressed transaction data, and sends the key information to the duplication judgment section 14b.

The key information storage section 18 stores the key information made by the key information making section 17 in a key information database 19 so that the key information is interrelated with the transaction data, and registers the key information so that it corresponds to the transaction data registered in the reception log database 16 shown in FIG. 6. This key information storage section 18 can employ, for example, a storage device such as a hard disk, etc.

In the electronic transaction system 1b of the second embodiment, the key information storage section 18 stores only the key information of transaction data judged not be duplicate reception by the duplication judgment section 14b.

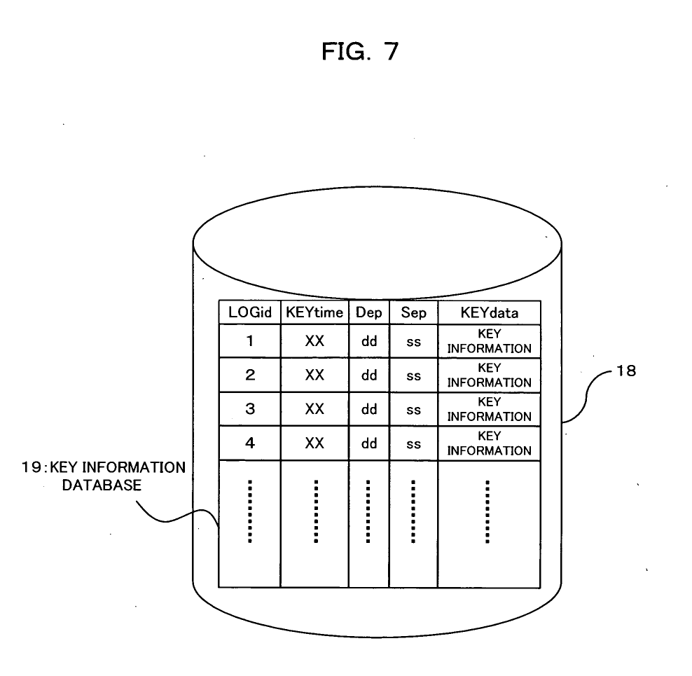

FIG. 7 is a diagram showing an example of the key information database 19 stored in the key information storage section 18 of the electronic transaction system 1b of the second embodiment of the present invention.

In the second embodiment, the key information database 19, as shown in FIG. 7, is constructed as a database table consisting of LOGid, KEYtime, Dep, Sep and KEY data columns. According to each transaction data judged not to be duplicate reception by the duplication judgment section 14b, the LOGid, KEYtime, Dep, Sep and KEY data (KEY information) columns are stored so that they are interrelated with each other. In FIG. 7, the same reference numerals as the aforementioned reference characters denote the same or nearly the same parts, so a detailed description of the corresponding parts will not be given.

The “KEYtime” column indicates the day and time when key information made by the key information making section 17 was written to the key information database 19. In the “KEYdata” column, key information made by the key information making section 17 is stored. Note in FIG. 7 that the “KEYtime” column shows XX's for convenience, but actually indicates the aforementioned day and time.

In the electronic transaction system 1b of the second embodiment, for new judgment object transaction data received by the receiver section 12, the duplication judgment section 14b first compares judgment object key information made based on the new judgment object transaction data by the key information making section 17 with key information stored in the key information storage section 18.

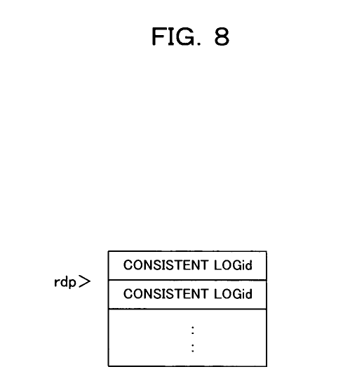

Based on the comparison, the duplication judgment section 14b collects the LOGid's of transaction data having the same key information (related) as the judgment object key information and makes a LOGid collection list (CLOGid). FIG. 8 is a diagram showing an example of a LOGid collection list made by the duplication judgment section 14b of the electronic transaction system 1b of the second embodiment. In the figure, along with the LOGid collection list, there is shown a pointer “rdp” which indicates a position in the LOGid collection list.

In the case where the same key information as the judgment object key information made by the key information making section 17 has been stored in the key information storage section 18, the duplication judgment section 14b compares the judgment object transaction data interrelated with the judgment object key information with a reception log relating to the same key information as the judgment object key information stored in the reception log storage section 13 (reception log database 16), and when these transaction data are the same, judges that the judgment object transaction data has been duplicatively received.

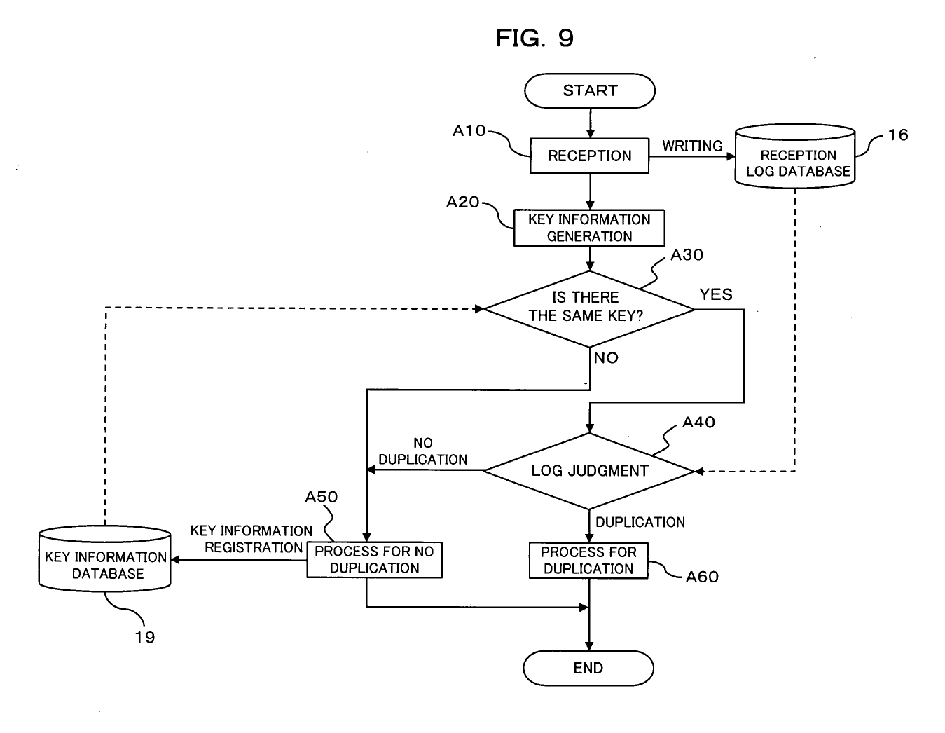

Now, the processing at the time of the reception of transaction data in the transaction server 10b of the electronic transaction system 1 of the second embodiment of the present invention will be described according to a flowchart (steps A10 to A60) shown in FIG. 9.

If the receiver section 12 receives judgment object transaction data transmitted from the transaction terminal 20, the judgment object transaction data is stored in the reception log database 16 of the reception log storage section 13 (step A10; reception log storage step). Then, the key information making section 17 makes judgment object key information, based on the judgment object transaction data (step A20; key information making step).

Based on judgment object key information made from the judgment object transaction data received by the receiver section 12 and on the key information database 19 of the reception log storage section 13, the duplication judgment section 14b judges whether the same key information as the judgment object key information has been stored in the key information database 19 (step A30; duplication judgment step). When the same key information as the judgment object key information has not been stored in the key information database 19, that is, when transaction data has not been duplicatively received (see the “NO” route of step A30), the duplication judgment section 14b judges that the judgment object transaction data has not been duplicatively received. The transaction processing section 15 processes the transaction data and stores the key information in the key information database 19 of the key information storage section 18 (step A50; key information storage step).

In the case where the same key information as judgment object key information has been stored in the key information database 19 (see the “YES” route of step A30), the duplication judgment section 14b judges whether the same transaction data as the transaction data (judgment object transaction data) corresponding to the judgment object key information has been stored in the reception log of the reception log database 16 (step A40; duplication judgment step).

In the case where the same transaction data as judgment object transaction data has been stored in the reception log database 16 (see the “Duplication” route of step A40), the duplication judgment section 14b judges that the judgment object transaction data has been duplicatively received. The transaction processing section 15 does not process the judgment object transaction data (step A60). In the case where the same transaction data as judgment object transaction data has not been stored in the reception log database 16 (see the “No duplication” route of step A40), the processing advances to step A50.

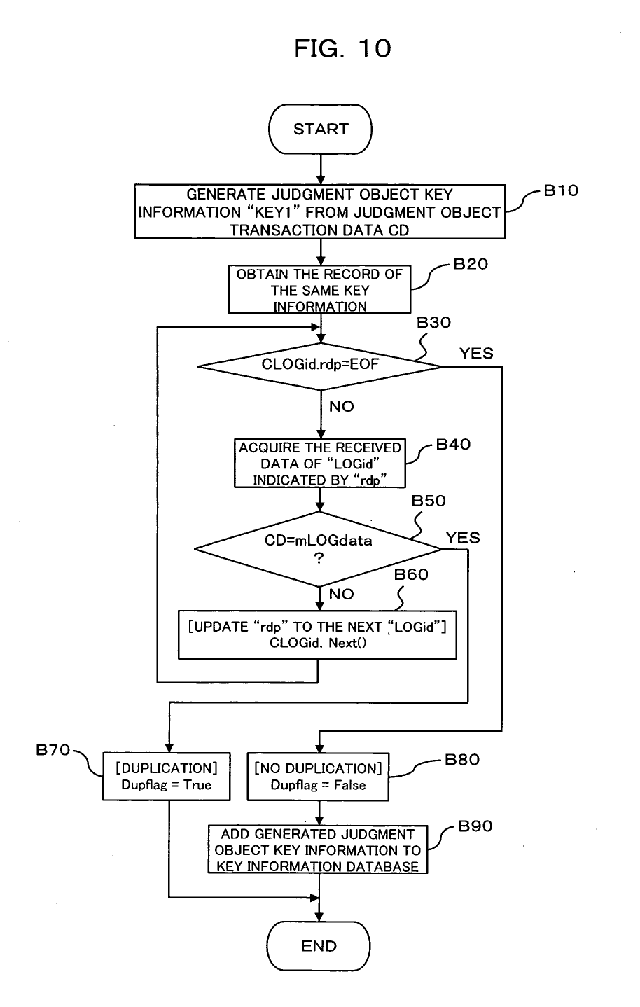

A method of judging duplicate reception by the electronic transaction system 1b of the second embodiment of the present invention will be described in more detail according to a flowchart (steps B10 to B90) shown in FIG. 10.

If the receiver section 12 receives transaction data CD (judgment object transaction data CD), the duplication judgment section 14b receives the transmitting-side end point identification information (pSep), receiving-side end point identification information (pDep), and reception log record identifier (pLOGid) from the receiver section 12, along with the judgment object transaction data CD, and begins to judge whether the transaction data has been duplicatively received.

First, the key information making section 17 makes judgment object key information by applying a message digest function (hash function) to the judgment object transaction data CD received by the receiver section 12 (key information making step). That is, by inputting all of the received judgment object transaction data CD into the hash function, the key information making section 17 generates a hash value and makes judgment object key information. Note in FIG. 10 that the calculated judgment object key information is represented by reference character key1 (step B10).

Next, the duplication judgment section 14b selects a record where the judgment object key information key1 obtained in step B10 is consistent with key information (keydata), by referring to the key information database 19, and makes a LOGid collection list (CLOGid) (step B20). The step B20 can be realized, for example, by the following SQL expression (program):

USE key information database

CLOGid<-SELECT LOGid FROM TABLE WHERE Dep=pDep AND Sep AND KEYdata=Key1

In the SQL expression, the LOGid collection list (CLOGid) is made by selecting and collecting the LOGid of the transaction data which has the same transmitting-side end point identification information, receiving-side endpoint identification information, and key information, based on the judgment object transaction data received by the receiver section 12 and on the transaction data stored in the reception log storage section 13.

In step B20, as shown in the aforementioned SQL expression, a record having the same transmitting-side end point identification information and receiving-side end point identification information may be selected. This makes it possible to reduce the number of LOGid's which form the LOGid collection list (CLOGid), so that the subsequent steps (steps B30 to B60, etc.) can be speeded up.

Next, for the made LOGid collection list (CLOGid), the pointer “rdp” is set to the first LOGid and it is then confirmed whether CLOGid=EOF (the end of a file) (step B30).

When the pointer “rdp” is not EOF (see the “NO” route of step B30), the transaction data CD corresponding to the LOGid indicated by the pointer “rdp” is obtained from the reception log database 16 (step B40). The step B40 can be realized, for example, by the following SQL expression:

USE reception log database

mLODdata<-SELECT LOGdata FROM TABLE WHERE LOGid=CLOGid.rdp

where “mLODdata” temporarily stores transaction data obtained from the reception log database 16 and “CLOGid.rdp” represents the LOGid of the LOGid collection list (CLOGid) indicated by the pointer “rdp.”

Next, the duplication judgment section 14b judges whether the judgment object transaction data CD obtained by the receiver section 12 is the same as “mLODdata,” that is, whether the judgment object transaction data CD has been duplicatively received (step B50; duplication judgment step). In the case where the judgment object transaction data CD is the same as “mLODdata” (see the “YES” route of step B50), the duplication judgment section 14b judges that the judgment object transaction data CD has been duplicatively received, sets a flag (True) which indicates duplicate reception to the duplication information (Dupflag) (step B70), and finishes the processing.

In the case where whether the judgment object transaction data CD is not the same as “mLODdata” (see the “NO” route of step B50), the pointer “rdp” is updated to a value which indicates the next LOGid (step B60) and the processing returns to step B30. The step B60 can be realized, for example, by the following program (command):

CLOGid.NEXT( )

On the other hand, when the position of the pointer “rdp” is EOF (see the “YES” route of step B30), it is judged that the judgment object transaction data CD has not been duplicatively received. And a flag (False) indicating no duplicative reception is set to the duplication information (Dupflag) (step B80), the generated judgment object key information key1 is registered in the key information database 19 (step B90; key information storage step), and the processing is finished.

That is, a new record is added to the key information database 19 by respectively registering the reception log record identifier (pLOGid), GETDATA( ), receiving-side end point identification information (pDep), transmitting-side end point identification information (pSep), and key inforation (Key1) in the LOGid, KEYtime, Dep, Sep, and KEYdata columns.

And as a result of the aforementioned duplicate reception judgment, the duplication judgment section 14b sends the transaction data CD, transmitting-side endpoint identification information (pSep), receiving-side end point identification information (pDep), and duplication information (Dupflag) to the transaction processing section 15.

According to the electronic transaction system 1b of the second embodiment of the present invention, the duplication judgment section 14b performs a first retrieval of key information on the key information database 19 stored in the key information storage section 18, employing judgment object key information, and performs a comparison of transaction data only on transaction data (LOGid) whose key information was judged to be duplicate information. Therefore, in addition to gaining the same advantages as those of the first embodiment, the number of transaction data to be retrieved from the reception log database 16 is reduced and the retrieval time to the reception log database 16 can be shortened. This makes the speed up of the judgment process in the duplication judgment section 14b possible.

In addition, the duplication judgment section 14b makes a judgment of duplication between judgment object key information and key information database 19 and then makes a judgment of duplication between judgment object transaction data and reception log database 16. Thus, since double duplication judgments are made, the results of the duplicate reception judgment of transaction data are obtained with high reliability.

Moreover, even in the case where transaction data received by the receiver section 12 has been compressed or encrypted, the key information making section 17 makes key information, based on the transaction data being compressed or encrypted, and the duplication judgment section 14b makes a judgment of duplication based on the thus-made key information. Therefore, a judgment of duplication can be made at high speed, and there is no possibility that the ability of the transaction server 10b to receive transaction data will be reduced.

### (C) Other Embodiments

In the above-described embodiments, each of the transaction servers 10a, 10b can be realized by a computer (information processor) having a server function, and the central processing unit of an information processor functions as the above-described duplication judgment sections 14a, 14b, transaction processing section 15, and key information making section 17 by carrying out a duplication judgment program.

The duplication judgment program for realizing the respective functions of the duplication judgment sections 14a, 14b, transaction processing section 15, and key information making section 17 is provided in a form stored in a computer-readable storage medium such as a flexible disk, CD-ROM, CD-R, CD-R/W, DVD, DVD-R, DVD-R/W, a magnetic disk, an optical disk, a magneto-optical disk, etc. And computers employ the duplication judgment program by reading from the storage medium and transferring to its internal or external storage device. Also, by storing the program in a storage device (storage medium) such as a magnetic disk, an optical disk, a magneto-optical disk, etc., it may be transferred from the storage device to computers through a communication line.

In realizing the respective functions of the duplication judgment sections 14a, 14b, transaction processing section 15, and key information making section 17, the duplication judgment program stored in an internal storage device (the hard disk or memory of an information process, etc.) is carried out by the microprocessor of a computer (in this embodiment, the central processing unit of a printer). At this time, a computer may implement the program by reading from a storage medium.

In this embodiment, a computer is a concept including both hardware and an operating system and means hardware that operates under the control of an operating system. In the case where hardware is operated by an application program alone without using an operating system, the hardware itself is equivalent to a computer. Hardware includes at least a microprocessor such as a CPU, and means for reading computer programs stored in a storage medium. In this embodiment, the transaction servers 10a and 10b have computer functions.

The storage medium in this embodiment, in addition to the above-described flexible disk, CD-ROM, CD-R, CD-R/W, DVD, DVD-R, DVD-R/W, magnetic disk, optical disk, and magneto-optical disk, can utilize various computer-readable media such as an IC card, a ROM cartridge, magnetic tape, a punch card, a computer internal storage device (memory such as RAM, ROM, etc.), an external storage device, a print with bar codes, etc.

While the present invention has been described with reference to the preferred embodiments thereof, the invention is not to be limited to the details given herein, but may be modified within the scope of the invention hereinafter claimed.

For example, in the above-described embodiments, when a duplication flag indicating duplicate reception is set to duplication information (Dupflag), that is, when the duplication judgment sections 14a, 14b judge that judgment object transaction data has been duplicatively received, the transaction processing section 15 does not process the transaction data. For this purpose, the electronic transaction system of the present invention may include a section for discarding the transaction data.

In the above-described second embodiment, the key information making section 17 generates a hash value by employing the message compression algorithm of the Message Digest5 (MD5) and employs the generated hash value as key information. However, the present invention is not limited to MD5, but may employ other message compression algorithms such as MD4, MD2, etc. The key information may be generated by various methods.

The key information making section 17 may be constructed so that it can make key information by a plurality of message compression algorithms such as MD5, MD4, MD2, etc. In this case, by selecting one of the message compression algorithms, key information may be made.

For instance, by respectively setting message compression algorithms to the end points which transmit and receive transaction data, the key information making section 17 may select one of the message compression algorithms according to a combination of the transmitting-side end point identification information (“Sep”) and receiving-side end point identification information (“Dep”) and make key information.

In the electronic transaction system 1b of the above-described second embodiment, for judgment object transaction data, the duplication judgment section 14b may compare the judgment object key information made based on the judgment object transaction data by the key information making section 17 with key information stored in the key information storage section 18, and when the same key information as the judgment object key information has been stored in the key information storage section 18, judge that the judgment object transaction data has been duplicatively received.

That is, when judgment object key information is the same as key information stored in the key information storage section 18, it may be judged that the judgment object transaction data has been duplicatively received, without making a direct comparison of the judgment object transaction data. Since this makes it unnecessary to directly compare and judge transaction data, the duplication judgment process can be performed at high-speed. In this case, it is desirable that key information can univocally specify transaction data.

In the above-described second embodiment, the key information storage section 18 stores only the key information interrelated with transaction data judged not to be duplicate reception by the duplication judgment section 14b. However, the present invention is not limited to this example. Regardless of duplicate reception, key information made by the key information making section 17 may be stored in the key information storage section 18 so that it is interrelated with the transaction data.

Furthermore, the key information storage section 18 and the reception log database 16 may be formed as a single database.

Now that the preferred embodiments of the present invention have been described, it will be apparent to those skilled in this art that the duplication judgment unit, electronic transaction unit, method of duplicate reception judgment, duplicate reception judgment program, and computer-readable storage medium storing the program of the present invention can be easily implemented and manufactured.

### INDUSTRIAL APPLICABILITY

As set forth above, the duplication judgment unit, electronic transaction unit, method of duplicate reception judgment, duplicate reception judgment program, and computer-readable storage medium storing the program of the present invention are useful in judging the duplicate reception of information transmitted from a transmission source, and are particularly suitable for receiving commercial transaction data in electronic commercial transactions.

What is claimed is:

1. A duplicate reception judgment unit for judging duplicate reception, in a transmission destination, of transaction information about an electronic transaction transmitted from a transmission source to the transmission destination, comprising:
a reception log storage section for storing as a reception log said transaction information received in said transmission destination; and
a duplication judgment section for judging duplicate reception of judgment object transaction information received in said transmission destination, based on said reception log stored in said reception log storage section.

2. The duplicate reception judgment unit as set forth in claim 1, wherein said duplication judgment section compares said judgment object transaction information with said reception log stored in said reception log storage section, and when the same transaction information as said judgment object transaction information has been stored as said reception log in said reception log storage section, judges that said judgment object transaction information has been duplicatively received.

3. The duplicate reception judgment unit as set forth in claim 1, further comprising:
a key information making section for making key information by applying a hash function to said transaction information received in said transmission destination; and
a key information storage section for storing said key information made by said key information making section so that it is interrelated with said transaction information;
wherein said duplication judgment section compares judgment object key information made based on said judgment object transaction information by said key information making section with said key information stored in said key information storage section, and when the same key information as said judgment object key information has been stored in said key information storage section, judges that said judgment object transaction information interrelated with said judgment object key information has been duplicatively received.

4. An electronic transaction unit comprising:
a receiver section for receiving transaction information about an electronic transaction transmitted from a transmission source;
a transaction processing section for performing a transaction process based on said transaction information received by said receiver section;
a reception log storage section for storing as a reception log said transaction information received by said receiver section; and
a duplication judgment section for judging duplicate reception of judgment object transaction information received by said receiver section, based on said reception log stored in said reception log storage section;
wherein said transaction processing section does not perform said transaction process on said judgment object transaction information judged to be said duplicate reception.

5. The electronic transaction unit as set forth in claim 4, further comprising:
a key information making section for making key information by applying a hash function to said transaction information received by said receiver section; and
a key information storage section for storing said key information made by said key information making section so that it is interrelated with said transaction information;
wherein said duplication judgment section compares judgment object key information made based on said judgment object transaction information by said key information making section with said key information stored in said key information storage section, and when the same key information as said judgment object key information has been stored in said key information storage section, judges that said judgment object transaction information interrelated with said judgment object key information has been duplicatively received.

6. A duplicate reception judgment method of judging duplicate reception, a transmission destination, of transaction information about an electronic transaction transmitted from a transmission source to the transmission destination, comprising:
a reception log storage step of storing as a reception log said transaction information received in said transmission destination; and
a duplication judgment step of judging duplicate reception of judgment object transaction information received in said transmission destination, based on said reception log stored in said reception log storage step.

7. The duplicate reception judgment method as set forth in claim 6, further comprising:
a key information making step of making key information by applying a hash function to said transaction information received in said transmission destination; and
a key information storage step of storing said key information made in said key information making step so that it is interrelated with said transaction information;
wherein, in said duplication judgment step, judgment object key information made based on said judgment object transaction information in said key information making step is compared with said key information stored in said key information storage step, and when the same key information as said judgment object key information has been stored in said key information storage step, it is judged that said judgment object transaction information interrelated with said judgment object key information has been duplicatively received.

8. A duplicate reception judgment program for judging duplicate reception, a transmission destination, of transaction information about an electronic transaction transmitted from a transmission source to the transmission destination, said program causing a computer to carry out:
a reception log storage step of storing as a reception log said transaction information received in said transmission destination; and
a duplication judgment step of judging duplicate reception of judgment object transaction information received in said transmission destination, based on said reception log stored in said reception log storage step.

9. The duplicate reception judgment program as set forth in claim 8, wherein, in causing said computer to carry out said duplication judgment step, said computer is caused to compare said judgment object transaction information with said reception log stored in said reception log storage step, and when the same transaction information as said judgment object transaction information has been stored as said reception log in said reception log storage step, judge that said judgment object transaction information has been duplicatively received.

10. The duplicate reception judgment program as set forth in claim 8, further causing said computer to carry out:
a key information making step of making key information by applying a hash function to said transaction information received in said transmission destination; and
a key information storage step of storing said key information made in said key information making step so that it is interrelated with said transaction information;
wherein, in causing said computer to carry out said duplication judgment step, said computer is caused to compare judgment object key information made based on said judgment object transaction information in said key information making step with said key information stored in said key information storage step, and when the same key information as said judgment object key information has been stored in said key information storage step, judge that said judgment object transaction information interrelated with said judgment object key information has been duplicatively received.

11. A computer-readable storage medium that has stored a duplicate reception judgment program for judging duplicate reception, in a transmission destination, of transaction information about an electronic transaction transmitted from a transmission source to the transmission destination, said program causing a computer to carry out:
a reception log storage step of storing as a reception log said transaction information received in said transmission destination; and
a duplication judgment step of judging duplicate reception of judgment object transaction information received in said transmission destination, based on said reception log stored in said reception log storage step.

12. The computer-readable storage medium as set forth in claim 11, wherein, in causing said computer to carry out said duplication judgment step, said computer is caused to compare said judgment object transaction information with said reception log stored in said reception log storage step, and when the same transaction information as said judgment object transaction information has been stored as said reception log in said reception log storage step, judge that said judgment object transaction information has been duplicatively received.

13. The computer-readable storage medium as set forth in claim 11, wherein said duplication judgment program further causes said computer to carry out:
a key information making step of making key information by applying a hash function to said transaction information received in said transmission destination; and
a key information storage step of storing said key information made in said key information making step so that it is interrelated with said transaction information;
and wherein, in causing said computer to carry out said duplication judgment step, said computer is caused to compare judgment object key information made based on said judgment object transaction information in said key information making step with said key information stored in said key information storage step, and when the same key information as said judgment object key information has been stored in said key information storage step, judge that said judgment object transaction information interrelated with said judgment object key information has been duplicatively received.
